(19) United States
(12) Patent Application Publication
(10) Pub. No.: US 2007/0030164 A1
(43) Pub. Date: Feb. 8, 2007

(54) MULTI-REMOTE CONTROLLER

(76) Inventor: Dae Hyuk LIM, Seoul (KR)

Correspondence Address: IPLA P.A., 3580 WILSHIRE BLVD., 17TH FLOOR, LOS ANGELES, CA, 90010, US

(21) Appl. No.: 11/459,870

(22) Filed: Jul. 25, 2006

(30) Foreign Application Priority Data
Aug. 5, 2005 (KR) 10-2005-0071530

(51) Int. Cl. G08B 5/22

(52) U.S. Cl. 340/825.49; 340/825.52; 340/539.32; 340/7.2

(57) ABSTRACT

A multi-remote controller for easily locating “paging objects” such as a car key, a TV remoter controller, etc. using one pager and a plurality of receivers connected to the paging objects, for receiving signals from the pager, is provided. In the multi-remote controller, a pager receives a whole or part of a paging code formed of digits from a user, generates a signal corresponding to the paging code, and outputs the signal externally. At least one receiver receives the signal from the pager, converting the signal to the paging code, compares the paging code with a registered paging code, and outputs a paging response if the paging codes are identical. The present invention advantageously enables a user to easily locate a frequently lost paging object like a car key, a TV remote controller, etc. without the need for purchasing a new one or finding for it, taking much time.

### FOREIGN PRIORITY CLAIMING

Applicant claims foreign priority under Paris Convention and 35 U.S.C. § 119 to a Korean Patent Application No. 10-2005-0071530, filed Aug. 5, 2005 with the Korean Intellectual Property Office.

### BACKGROUND OF THE INVENTION

1. Field of the Invention

The present invention relates generally to a multi-remote controller for easily locating “paging objects” such as a car key, a TV remoter controller, etc. using one pager and a plurality of receivers connected to the paging objects, for receiving signals from the pager, and in particular, to a multi-remote controller configured to notify a user of the position of a paging object by connecting a plurality of receivers to paging objects, such as an entrance hall key, a car key, a TV remote controller, a mobile phone, etc. by means of loops, magnets, or an adhesive, registering the paging codes of the receivers in a pager, generating a signal or a signal wave having a “signal property” preset with respect to a paging code and sending the signal from the pager, upon receipt of a whole or a part of the paging code from a user, converting the signal to the paging code at a receiver that has received the signal, and outputting voice through a speaker, emitting light through a lamp like an LED (Light Emitting Diode), or generating vibrations by driving a vibration motor at the receiver, if the paging code is identical to that of the receiver.

2. Description of the Related Art

Conventionally, there was no remote controller that can locate all of small-size, frequently used items such as a TV remote controller, an audio remoter controller, an entrance hall key, a car key, a mobile phone (out of battery), etc. and notify a user of their locations, although some electronic appliance is equipped with a pager for locating a dedicated remote controller of the electronic appliance.

Therefore, when the user cannot locate such items, he has to purchase new ones or be patient enough to find them.

Moreover, mounting a pager onto an electronic appliance faces the problems of incompatibility with other appliances and product cost increase. The resulting doubt in its effectiveness makes users apathetic.

### SUMMARY OF THE INVENTION

An object of the present invention is to substantially solve at least the above problems and/or disadvantages and to provide at least the advantages below. Accordingly, the present invention provides a multi-remote controller which has a pager and a plurality of receivers, the pager including a keypad with a plurality of digit buttons with natural numbers 1, 2, 3, . . . and character buttons for invoking predetermined functions, for receiving a number such as a paging code from a user and a signal output command, a receiver register for registering the paging codes of the receivers and signal properties for the paging codes, a signal generator for searching the receiver register for a signal property corresponding to a paging code received from the keypad, reading the signal property, and generating the signal having the signal property, a signal transmitter for externally transmitting the signal received from the signal generator after modulation or amplification so that the signal can be received at a corresponding receiver, an operation controller for preventing malfunction of the pager by eliminating or blocking an externally introduced interference signal, providing the signal property corresponding to the paging code, and controlling operations of the keypad, the receiver register, the signal generator, and the signal transmitter, and a power supply for supplying an operation power to the pager, and each of the receivers including a signal receiver for receiving a signal from the pager and converting the received signal to the paging code, a code identifier for comparing the paging code with the registered paging code specific to the receiver, a paging response transmitter for externally outputting the paging response if the paging codes are identical, an operation controller for controlling the paging response transmitter to or not to output the paging response depending on whether the paging codes are identical or different, and controlling operations of the signal receiver, the code identifier, and the paging response transmitter, and a power supply for supplying an operation power to the receiver.

Ultimately, the present invention provides a multi-remote controller for enabling a user to easily locate an intended paging object, such as a TV remote controller, an audio controller, an entrance hall key, a car key, or even a mobile phone, without the need for purchasing a new one or taking much time in finding for the paging object, when he cannot locate the paging object, for allowing an easy connection of a receiver to a new paging object if an old paging object such as a mote controller or a mobile phone is replaced with the new one because of breakage of the old paging object or purchasing the new one, and for allowing a receiver to be added as far as the receiver can be matched to a pager.

The above object is achieved by providing a multi-remote controller. According to one aspect of the present invention, in a multi-remote controller, a pager receives a whole or part of a paging code formed of digits from a user, generating a signal (or a signal wave) corresponding to the paging code, and outputs the signal externally. At least one receiver receives the signal from the pager, converting the signal to the paging code, compares the paging code with a registered paging code, and outputs a paging response if the paging codes are identical.

The pager includes a keypad having a plurality of buttons with natural numbers 1, 2, 3, . . . or sequential characters and at least one of a power On/Off button and an Enter button, for receiving the whole or part of the paging code for paging the at least one receiver, and a command requesting transmission of the signal corresponding to the paging code to the at least one receiver indicated by the paging code, a receiver register for registering the paging code and a signal property describing at least one of the frequency, amplitude, and strength of the signal corresponding to the paging code, the paging code being a combination of a pager code of the pager and a receiver code allocated to the at least one receiver, a signal generator for, upon receipt of the paging code from the keypad, searching the receiver register for the signal property corresponding to the paging code, reading the signal property, and generating the signal having the signal property, a signal transmitter for externally transmitting the signal received from the signal generator without amplification or modulation, or after modulation or amplification so that the signal can be received at the at least one receiver, an operation controller for preventing malfunction of the pager by eliminating or blocking an externally introduced interference signal, providing the signal property corresponding to the paging code, and controlling operations of the keypad, the receiver register, the signal generator, and the signal transmitter, and a power supply for supplying an operation power to the pager.

The at least one receiver includes a signal receiver for receiving the signal from the pager and converting the received signal to the paging code, a code identifier for comparing the paging code with the registered paging code specific to the at least one receiver, a paging response transmitter for externally outputting the paging response if the paging codes are identical, an operation controller for controlling the paging response transmitter to or not to output the paging response depending on whether the paging codes are identical or different, and controlling operations of the signal receiver, the code identifier, and the paging response transmitter, and a power supply for supplying an operation power to the receiver.

In addition, the pager further includes a display for visually displaying digits received from the keypad or a number or characters representing the name of a paging object (e.g. an entrance hall key, a car key, a remote controller, etc.) corresponding to the paging code.

The paging response transmitter in the at least one receiver includes at least one of a speaker as voice output means, a lamp as light emitting means, and a vibration motor as vibration output means.

According to another aspect of the present invention, in a multi-remote controller, a pager receives a whole or part of a paging code formed of digits from a user, generating a signal (or a signal wave) corresponding to the paging code, and outputs the signal externally. Each of a plurality of receivers receives the signal from the pager, converts the signal to the paging code, compares the paging code with a registered paging code, and outputs a paging response by at least one of voice, light, and vibrations if the paging codes are identical. The pager is fixed or attached to one of an indoor wall and electronic appliances including a refrigerator, an air conditioner, and a television by at least one of a magnet, an adhesive, and an adhesive tape. The receivers are fixed or connected in a one-to-one correspondence to paging objects including an entrance hall key, a car key, a television remote controller, and a mobile phone by at least one of a loop, a magnet, an adhesive, and an adhesive tape.

### BRIEF DESCRIPTION OF THE DRAWINGS

The above and other objects, features and advantages of the present invention will become more apparent from the following detailed description when taken in conjunction with the accompanying drawings in which:

FIG. 1A is an exterior perspective view of a multi-remote controller according to the present invention;

FIG. 1B is a sectional view of the multi-remote controller according to the present invention;

FIGS. 2A, 2B and 2C are views illustrating examples of using the multi-remote controller according to the present invention;

FIG. 3A illustrates a pager and paging objects connected to the pager through receivers in the multi-remote controller according to the present invention;

FIG. 3B illustrates an example of paging codes in the multi-remote controller according to the present invention; and

FIGS. 4A and 4B are block diagrams of the multi-remote controller according to an embodiment of the present invention.

### DETAILED DESCRIPTION OF THE PREFERRED EMBODIMENT

A preferred embodiment of the present invention will be described herein below with reference to the accompanying drawings. In the following description, well-known functions or constructions are not described in detail since they would obscure the invention in unnecessary detail.

Main terms used herein will be first defined as follows.

“Paging object” refers to a device or a tool, such as an entrance hall key, a car key, a TV remote controller, and a mobile phone, which the user easily loses or can not locate frequently and thus to which the user integrally connects a receiver by a loop, a magnet, or an adhesive.

“Signal property” is a pre-registered condition for generating and outputting a signal wave having a frequency with a predetermined bandwidth so that each receiver can receive only a signal specific to the receiver from a pager, or can determine whether to output a paging response by voice or light, or by any other means even if all receivers receive the same signal from the pager.

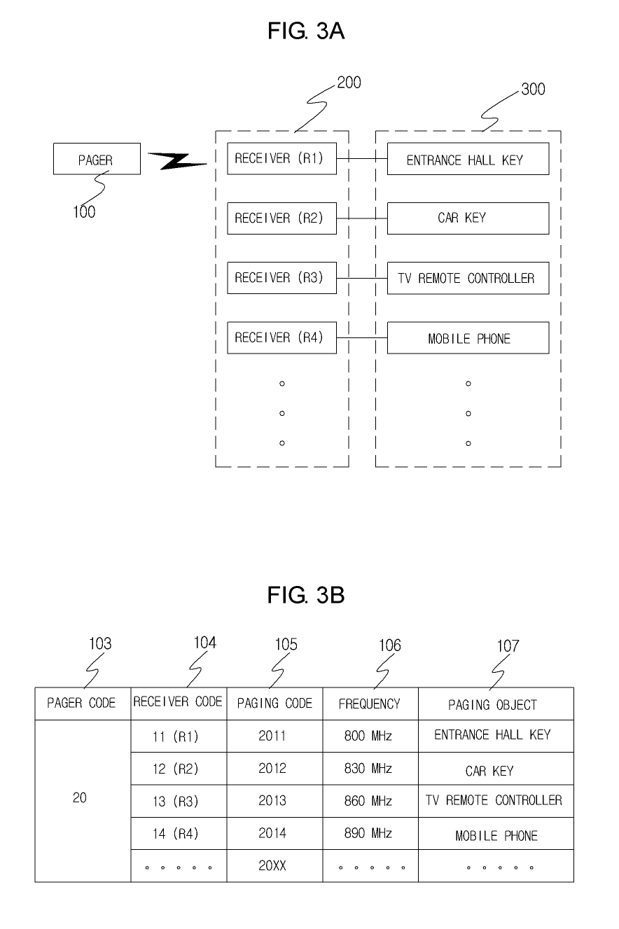

Referring to FIG. 3B, a paging code 105 refers to a number preset to page a specific receiver. While not specified, a paging code can be formed by combining a pager code 103 specific to the pager and a receiver code 104 specific to each receiver, for example. If the pager code 103 is “20”, the receiver Code 104 is “11” for a receiver R1, “12” for a receiver R2, “13” for a receiver R3, and “14” for a receiver R4, the paging codes 105 for the receivers R1 to R4 are “2011”, “2012”, “2013”, and “2014”, respectively. Each paging code is formed of the pager code 103 in the first half and a receiver code 104 in the last half. A signal property 106 can be set as “signal at 800 MHz” for the paging code 2011, and “signal at 860 MHz” for the paging code 2013. The pager outputs a signal with such a specific signal property and a receiver having a receiver code or a paging code corresponding to the signal property outputs a paging response.

In the above scenario where codes and signal properties are mapped to paging objects 107, if the pager code 103 is 20, the receiver code 104 is 13, the paging code 105 is 2013 and the signal property 106 corresponding to the paging code is “signal at 860 MHz”. The signal sent at 860 MHz can be a command or condition requesting that the receiver R1 outputs a paging response by voice or light to indicate the position of a TV remote controller being a paging object 107 connected to the receiver R1.

The configurations of the above-described codes and their configuring method may vary depending on availability at present or in the future. The signal properties can also be set in many ways.

The user can enter the whole of a paging code formed of a pager code and a receiver code. Or he enters only the receiver code and the pager itself reads a registered pager code and forms the paging code with the receiver code and the pager code.

Hereinbelow, a detailed description will be made of the present invention with reference to the attached drawings.

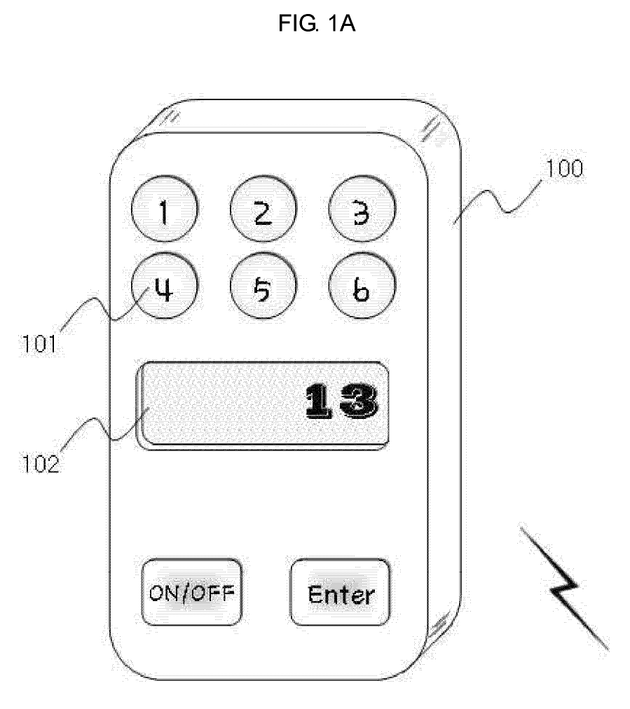

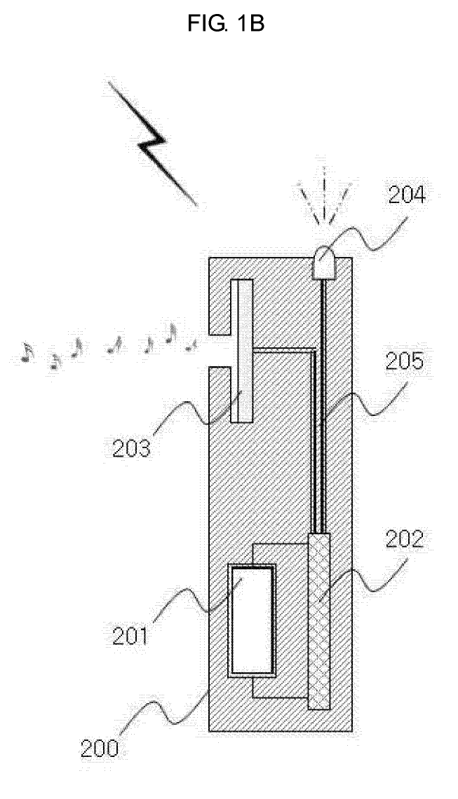

FIGS. 1A and 1B are respectively an exterior perspective view and a sectional view of the multi-remote controller according to the present invention.

Referring to FIG. 1A, a pager 100 is provided, at a frontal surface of its body, with digit buttons having digits 1, 2, 3, 4, . . . or sequential characters a, b, c, . . . , thereon and character buttons respectively having On/Off and Enter thereon. Part of the digit buttons and character buttons 101 may not be provided, and other buttons may be further provided to implement other various functions.

A display 102 can be further provided on the frontal surface of the body, for displaying digits entered by the user or displaying the name of a receiver corresponding to the digits, or the name of a paging object connected to the receiver in the form of a number or characters. Many modifications can be made to the shape of the pager 100 depending on design and usage.

Referring to FIG. 1B, a receiver 200 includes a battery 201 for supplying power, a circuit board 202 called a microprocessor, a chip, or any other name, and at least one of output means including a speaker (or a planar speaker) 203 for outputting voice, and a lamp (or LED) 204 for emitting light. The battery 201, the circuit board 202, the speaker 203, and the lamp 204 are connected by a conductive wire 205, thereby forming a circuit.

The receiver 200 may vary in shape depending on design and usage.

While not shown, the configurations of other components of the pager 100 are well-known to those skilled in the art and thus their description is not provided herein.

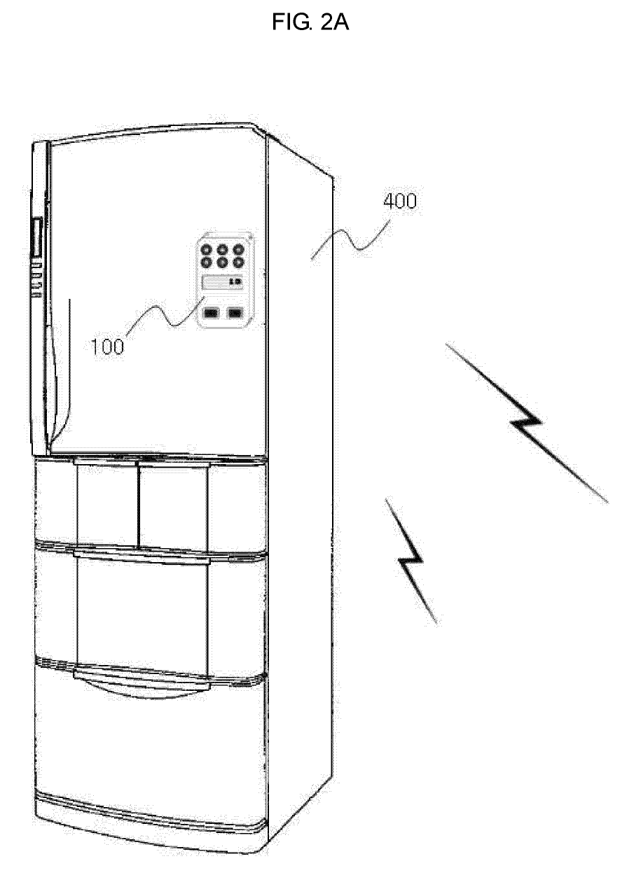

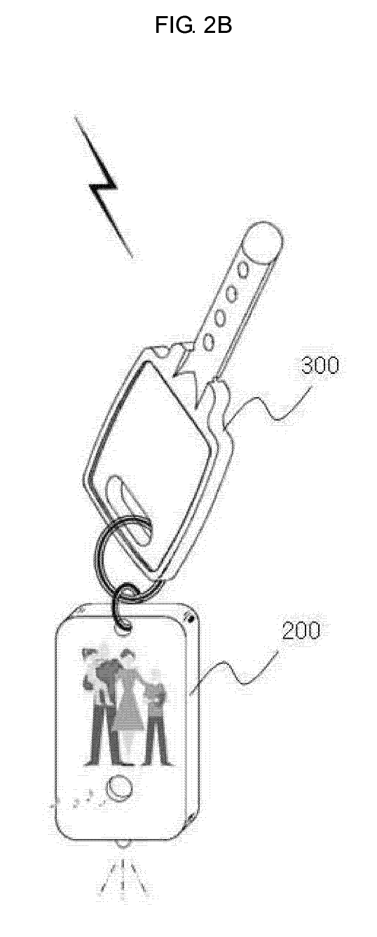

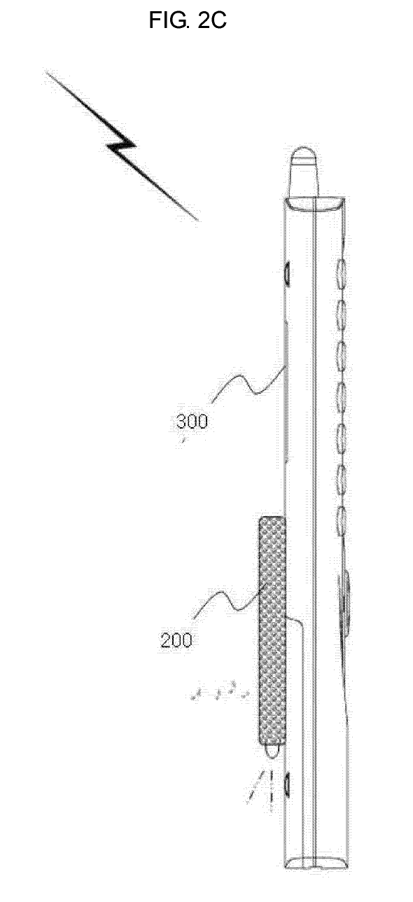

FIGS. 2A, 2B and 2C illustrate examples of using the multi-remote controller of the present invention.

Referring to FIG. 2A, the user attaches the pager 100 to an easily noticeable wall, or one surface of an electronic appliance 400 such as a refrigerator, an air conditioner, or a TV by attaching a magnet or coating an adhesive or an adhesive tape onto the rear surface of the pager 100.

Referring to FIGS. 2B and 2C, the user attaches the receiver 200 to a remote controller as a paging object 300 by applying a magnet or coating an adhesive or an adhesive tape onto the rear surface of the receiver 200. Or the user inserts a loop into one end of the receiver 200 and connects the receiver 200 to the paging object 300 like an entrance hall key or a car key by means of the loop.

FIGS. 3A and 3B are views illustrating the multi-remote controller of the present invention connected to paging objects and an example of paging codes. FIG. 3B has been described before in connection with term definitions and will not be provided again herein. Referring to FIG. 3A, a plurality of receivers 200, R1, R2, R3, R4, . . . can be registered to the pager 100. Each of the receivers 200 is connected to a paging object 300. For example, an entrance hall key is connected to the receiver R1, a car key to the receiver R2, and a TV remote controller to the receiver R3. Thus, as the user enters a whole or part of a paging code, the pager 100 generates a signal output command and a corresponding receiver 200 generates a paging response, thereby notifying the user of the position of a corresponding paging object.

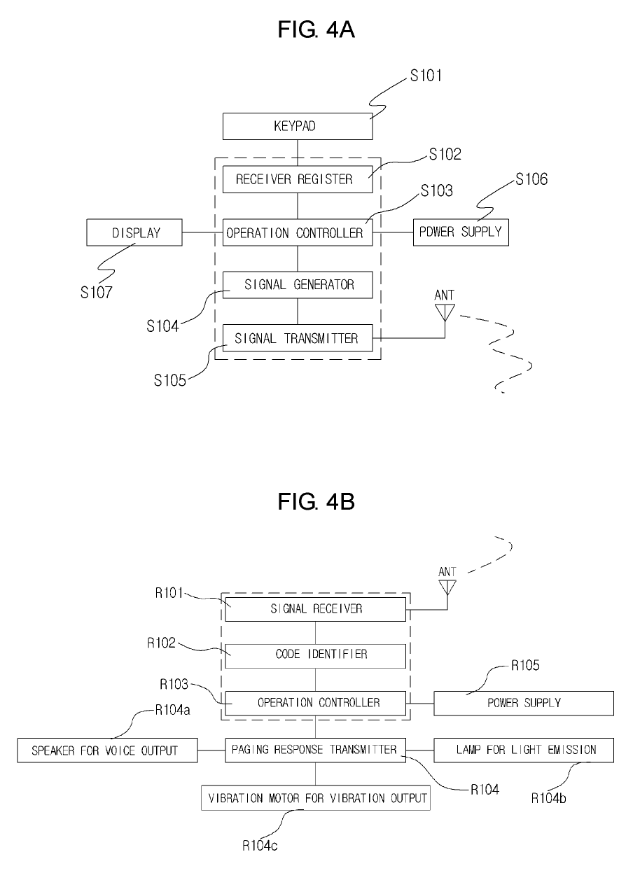

FIGS. 4A and 4B are block diagrams of the multi-remote controller according to an embodiment of the present invention.

Referring to FIG. 4A, the pager 100 includes a keypad S101, a receiver register S102, a signal generator S104, a signal transmitter S105, an operation controller S103, and a power supply S106. The keypad S101 is provided with digit buttons having natural numbers 1, 2, 3, . . . written thereon, and at least one of the power On/Off button and the Enter button. The keypad S101 receives a whole or part of a paging code for paging one of the receivers 200, and a command requesting transmission of a signal to the receiver corresponding to the paging code. The receiver register S102 registers paging codes, each formed of the pager code of the pager 100 and a receiver code allocated to each receiver, and signal properties corresponding to the paging codes, each signal property being set as at least one of the frequency, amplitude, and strength of a signal corresponding to a paging code. The signal generator S104, upon receipt of a paging code from the keypad S101, searches the receiver register S102 for a signal property corresponding to the paging code and generates a signal with the signal property. The signal transmitter S105 modulates or amplifies the signal received from the signal generator S104 so that the signal can arrive at the receiver, and transmits the signal externally through internal and external antennas, which cannot be provided. The operation controller S103 eliminates or blocks an external interference signal, to thereby prevent malfunction of the pager 100. It also provides the signal property corresponding to the paging code, and controls the operations of the keypad S101, the receiver register S102, the signal generator S104, and the signal transmitter S105. The power supply S106 supplies an operation power to the pager 100.

The pager 100 may be further provided with a display S107 for visually notifying the user of digits received from the keypad S101, or a number or characters representing the name of a paging object (i.e. an entrance hall key, a car key, a remote controller, etc.) corresponding to a paging code formed of the digits.

The functions of the keypad S101, the receiver register S102, the signal generator S104, the signal transmitter S105, the operation controller S103, the power supply S106, and the display S107 can be partially integrated, to thereby reduce the number of components in the pager 100. For example, the functions of the operation controller S103 are distributed to other components, which obviates the need for the operation controller S103. Or the function of the receiver register S102 is incorporated in the signal generator S104. On the contrary, the functions of a component can be separated. For example, the signal transmitter S105 can be separated into a signal amplifier and a signal transmitter.

Referring to FIG. 4B, the receiver 200 has a signal receiver R101, a code identifier R102, an operation controller R103, a paging response transmitter R104, and the power supply R105. The signal receiver R101 receives a signal from the pager 100 and converts the received signal to a paging code. The code identifier R102 compares the paging code with a registered paging code specific to the receiver 200. If the paging codes are identical, the paging response transmitter R104 outputs a paging response. The operation controller R103 controls the paging response transmitter R104 to determine whether to output the paging response based on the comparison result from the code identifier R102 and controls the operations of the signal receiver R101, the code identifier R102, and the paging response transmitter R104. The power supply R105 supplies an operation power to the receiver 200.

In addition, the paging response transmitter R103 can be provided with one or more of a speaker as voice output means, a lamp as light emitting means, and a vibration motor as vibration output means.

Like the pager 100, the number of the components in the receiver 200 can be reduced by partially integrating the functions of the signal receiver R101, the code identifier R102, the paging response transmitter R104, the operation controller S103, and the power supply R105. For example, the functions of the operation controller R103 are distributed to other components, which obviates the need for the operation controller R103. On the contrary, the functions of a specific component can be separated. For example, the signal receiver R101 is separated into a signal receiver and a signal converter.

As described above, the present invention pertains to a multi-remote controller having a pager and a plurality of receivers capable of receiving a signal from the pager, connected to paging objects including a car key, a TV remote controller, etc., in order to locate the paging objects easily.

According to the conventional technology, when a user cannot locate a TV remote controller, an audio controller, an entrance hall key, a car key, or even a mobile phone, he has to purchase a new one or find for an object of interest, taking much time. Even if a pager is mounted onto some electronic appliance, the pager is incompatible with other devices and its use increases product cost. The ineffectiveness of the use of pagers has made customers apathetic.

On the other hand, in the present invention, if the user cannot locate a paging object with a receiver attached or connected thereto, such as a TV remote controller, an audio controller, an entrance hall key, a car key, or even a mobile phone, he easily locates the paging object simply by pressing a button in a pager, without the need for purchasing a new one or taking much time in finding for the paging object. Therefore, time and cost are saved.

While the invention has been shown and described with reference to a certain preferred embodiment thereof, it will be understood by those skilled in the art that various changes in form and details may be made therein without departing from the spirit and scope of the invention as defined by the appended claims.

What is claimed is:

1. A multi-remote controller comprising:
a pager for receiving a whole or part of a paging code formed of digits from a user, generating a signal corresponding to the paging code, and outputting the signal externally; and
at least one receiver for receiving the signal from the pager, converting the signal to the paging code, comparing the paging code with a registered paging code, and outputting a paging response if the paging codes are identical.

2. The multi-remote controller of claim 1, wherein the pager comprises:
a keypad having a plurality of buttons with natural numbers or sequential characters and at least one of a power On/Off button and an Enter button, for receiving the whole or part of the paging code for paging the at least one receiver, and a command requesting transmission of the signal corresponding to the paging code to the at least one receiver indicated by the paging code;
a receiver register for registering the paging code and a signal property describing at least one of the frequency, amplitude, and strength of the signal corresponding to the paging code, the paging code being a combination of a pager code of the pager and a receiver code allocated to the at least one receiver;
a signal generator for, upon receipt of the paging code from the keypad, searching the receiver register for the signal property corresponding to the paging code, reading the signal property, and generating the signal having the signal property;
a signal transmitter for externally transmitting the signal received from the signal generator without amplification or modulation, or after modulation or amplification so that the signal can be received at the at least one receiver;
an operation controller for preventing malfunction of the pager by eliminating or blocking an externally introduced interference signal, providing the signal property corresponding to the paging code, and controlling operations of the keypad, the receiver register, the signal generator, and the signal transmitter; and
a power supply for supplying an operation power to the pager.

3. The multi-remote controller of claim 1, wherein the at least one receiver comprises:
a signal receiver for receiving the signal from the pager and converting the received signal to the paging code;
a code identifier for comparing the paging code with the registered paging code specific to the at least one receiver;
a paging response transmitter for externally outputting the paging response if the paging codes are identical;
an operation controller for controlling the paging response transmitter to or not to output the paging response depending on whether the paging codes are identical or different, and controlling operations of the signal receiver, the code identifier, and the paging response transmitter; and
a power supply for supplying an operation power to the receiver.

4. The multi-remote controller of claim 1, wherein the pager further comprises a display for visually displaying digits received from the keypad or a number or characters representing the name of a paging object (e.g. an entrance hall key, a car key, a remote controller, etc.) corresponding to the paging code.

5. The multi-remote controller of claim 1, wherein the paging response transmitter in the at least one receiver comprises at least one of a speaker as voice output means, a lamp as light emitting means, and a vibration motor as vibration output means.

6. A multi-remote controller comprising:
a pager for receiving a whole or part of a paging code formed of digits from a user, generating a signal corresponding to the paging code, and outputting the signal externally; and
a plurality of receivers, each for receiving the signal from the pager, converting the signal to the paging code, comparing the paging code with a registered paging code, and outputting a paging response by at least one of voice, light, and vibrations if the paging codes are identical,
wherein the pager is fixed or attached to one of an indoor wall and electronic appliances including a refrigerator, an air conditioner, and a television by at least one of a magnet, an adhesive, and an adhesive tape, and
wherein the receivers are fixed or connected in a one-to-one correspondence to paging objects including an entrance hall key, a car key, a television remote controller, and a mobile phone by at least one of a loop, a magnet, an adhesive, and an adhesive tape.
